(19) United States
(12) Patent Application Publication
(10) Pub. No.: US 2002/0132145 A1
(43) Pub. Date: Sep. 19, 2002

(54) Fuel cell with internal reformer and method for its operation

(76) Inventor: Walter Preidel, Erlangen (DE)

Correspondence Address: LERNER AND GREENBERG, P.A., Post Office Box 2480, Hollywood, FL, 33022-2480, US

(21) Appl. No.: 10/105,548

(22) Filed: Mar. 25, 2002

Related U.S. Application Data
(63) Continuation of application No. PCT/DE00/03167, filed on Sep. 12, 2000.

(30) Foreign Application Priority Data
Sep. 23, 1999 (DE) 199 45 667.4

(51) Int. Cl. H01M 8/06; H01M 8/10

(52) U.S. Cl. 429/13; 429/19; 429/20; 429/30

(57) ABSTRACT

A fuel cell is described which, depending on an operating mode is at times a direct methanol fuel cell and at times a hydrogen fuel cell. For this purpose, an internal reformer layer is fitted in each fuel cell unit, at which layer, given a sufficiently high pressure and/or temperature, the reforming reaction takes place, during which the fuel methanol/water is reacted to form hydrogen. The configuration of the reformer catalyst layer inside the cell ensures that the heat of the anode is used for reforming, and conversely the anode is cooled by the endothermic reforming reaction.

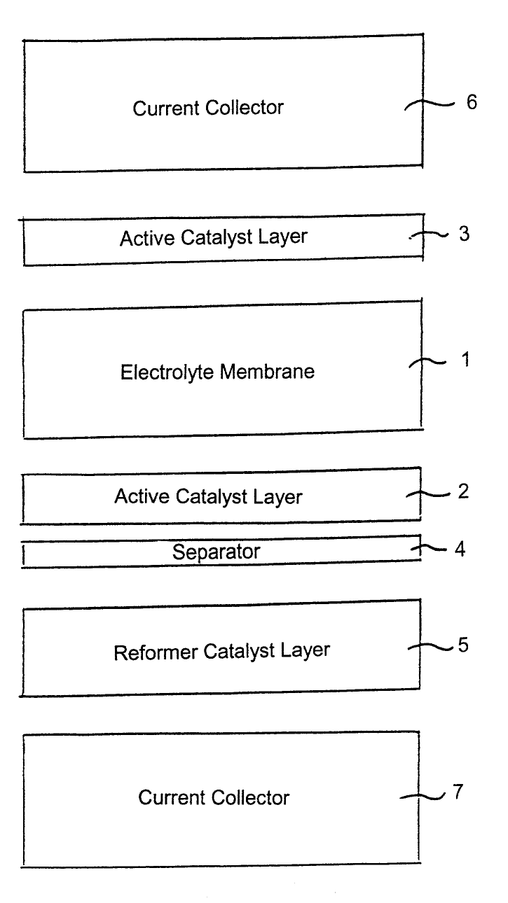

### CROSS-REFERENCE TO RELATED APPLICATION

This application is a continuation of copending International Application PCT/DE00/03167, filed Sep. 12, 2000, which designated the United States.

### BACKGROUND OF THE INVENTION

### Field of the Invention

The invention relates to a fuel cell having an internal reformer, including a reformer chamber, a membrane electrode assembly, including an anode chamber and an anodic electrode coating, and catalyst layers. The invention also relates to a method for operating a fuel cell of this type.

Published, Non-Prosecuted German Patent Application DE 196 256 21 A1 discloses a direct methanol fuel cell (DMFC) that is operated with a gaseous fuel. A drawback of the DMFC is that the fuel used is a methanol/water mixture, which achieves a lower power density in the cell than would be the case if pure hydrogen were to be reacted as the fuel.

Published, Non-Prosecuted German Patent Application DE 196 32 285 A1 discloses a membrane for a fuel cell that is stable and able to operate in the temperature range from −50° C. to 400° C. This material can be used as an electrolyte for a direct methanol fuel cell with an internal reformer.

Furthermore, International Patent Disclosure WO 99/08336 A2 discloses a fuel cell that operates with methanol, and contains an anode, an electrolyte and a cathode. In the fuel cell, on the anode side, there is a barrier layer which separates fuels and electrolyte, the barrier layer being permeable to hydrogen, and in which fuel cell, in addition, there is a catalyst which oxidizes the hydrogen passing through the barrier layer. In this way, hydrogen for the operation of the fuel cell is generated from the methanol by internal reforming.

### SUMMARY OF THE INVENTION

It is accordingly an object of the invention to provide a fuel cell with an internal reformer and a method for its operation which overcome the above-mentioned disadvantages of the prior art devices and methods of this general type, which has an improved the power density.

With the foregoing and other objects in view there is provided, in accordance with the invention, a fuel cell. The fuel cell contains a reformer having a reformer chamber, and a membrane electrode assembly having an anode chamber and an anodic electrode coating. The anodic electrode coating is suitable for a conversion of methanol and for a conversion of hydrogen. A reformer catalyst layer is disposed in the anode chamber following the anodic electrode coating of the membrane electrode assembly (MEA).

The subject of the invention is a fuel cell having a membrane electrode assembly and an internal reformer, in which a second catalyst layer for a reforming reaction is provided in the anode chamber following the anodic electrode coating, which is suitable both for the conversion of methanol and the conversion of hydrogen. When the pressure and/or operating temperature is sufficiently high, the reforming reaction takes place at the second catalyst layer, the fuel hydrogen being obtained from the fuel methanol/water. Since the second catalyst layer is disposed inside the anode reaction chamber, the configuration is a cell with an internal reformer.

In the method according to the invention, the fuel cell is operated at times as a direct methanol fuel cell with a methanol/water mixture as the fuel. If the operating pressure and/or operating temperature are sufficient, the reforming reaction may take place within the fuel cell, the fuel cell then operates with hydrogen as the fuel.

According to an advantageous configuration of the fuel cell, the active catalyst layer for the anodic oxidation, i.e. the anodic electrode coating of the membrane electrode assembly, is followed by a separator that lies between the two catalyst layers, is permeable to gas and/or liquid and conducts heat and electric current.

In accordance with an added feature of the invention, the anodic electrode coating has a catalyst and a concentration and/or a composition of the catalyst is variable.

In accordance with another feature of the invention, the reformer catalyst layer is present in an amount of from 3 to 50 mg/cm2.

In accordance with a further feature of the invention, the membrane electrode assembly has a membrane reinforced with a woven textile fabric.

With the foregoing and other objects in view there is further provided, in accordance with the invention a method for operating a fuel cell. The method includes the steps of operating the fuel cell at a low pressure and/or a low temperature as a direct methanol fuel cell (DMFC); and operating the fuel cell at a high pressure and/or a high temperature as a polymer electrolyte membrane (PEM) fuel cell operating with hydrogen.

In accordance with an additional mode of the invention, there is the step of utilizing the direct methanol fuel cell during a cold start of the fuel cell.

In accordance with an added mode of the invention, there is the step of reacting a liquid methanol/water mixture at an anode in an event of a cold start, while the fuel cell is starting up.

In accordance with another mode of the invention, during long-turn operation, an operating pressure and/or an operating temperature are sufficient for a reforming reaction to take place inside the fuel cell.

In accordance with a further mode of the invention, during operation, an operating temperature of at least 150° C. and/or an operating pressure of at least 5 bar prevails.

In accordance with a concomitant mode of the invention, during long-term operation, there is the step of operating the fuel cell as a high-temperature polymer electrolyte membrane (HT-PEM) fuel cell.

Other features which are considered as characteristic for the invention are set forth in the appended claims.

Although the invention is illustrated and described herein as embodied in a fuel cell with an internal reformer and a method for its operation, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE DRAWING

The single figure of the drawing is a diagrammatic, exploded view, so that layers that directly adjoin one another are shown as separate blocks for the sake of clarity and according to the invention.

### DESCRIPTION OF THE PREFERRED EMBODIMENTS

Referring now to the single figure of the drawing, there is shown an essential component of a membrane electrode assembly (MEA) for the embodiment of the direct methanol fuel cell that has a separator 4 between an anodic electrode coating of the MEA and a reformer catalyst layer. On the two outer ends, the MEA is in each case provided with a current collector 6, 7 which directly adjoin non-illustrated bipolar plates that surround each cell. The current collectors 6, 7 are used to tap current and, under certain circumstances, also as gas and/or liquid distributors, depending on the structure. The material used for the current collectors 6, 7 should be porous, have a good electronic conductivity and a low contact resistance. By way of example, carbon paper that has been treated, for example, with a hydrophobic polymer may be used at this point.

The bipolar plates, which are not shown in the figure, close off the fuel cell unit and are responsible for transporting a process gas, current and heat, and for cooling, may be made from different materials, for example from metal and/or carbon.

On a cathode side, the current collector 6 is adjoined by an active catalyst layer 3 for a cathodic reduction, which for its part directly adjoins an electrolyte 1. The electrolyte 1 is a membrane, which preferably has a good proton conductivity, does not necessarily require water for proton conduction and is thermally stable at least up to the upper operating temperatures of 250° C. A membrane of this type is known from Published, Non-Prosecuted German Patent Application DE 196 32 285 A1, which was cited in the introduction.

The electrolyte membrane 1 may be provided with an additional layer of a woven textile fabric for reinforcement or a textile inlay in order to save on ionomer. In particular the woven fabric inlay makes it possible to increase the mechanical strength of the electrolyte membrane 1 to such an extent that it compensates for some of the pressure on an anode side, so that the pressure on the cathode side does not necessarily have to be identical to the pressure on the anode side. As well as saving costs for the electrolyte membrane 1, a textile inlay forming from 20 to 70% of the volume also leads to a huge increase in the compressive strength. This also allows the thickness of the membrane 1 to be reduced significantly.

The electrolyte 1 is adjoined by an active catalyst layer 2 for the anodic oxidation, which is separated from a reformer catalyst layer 5 by the separator 4. The separator 4, like the current collectors 6 and 7, may be formed from thin carbon paper, since the demands imposed on both components are similar. The separator 4 is thinner than the current collectors 6 and 7.

The reformer catalyst layer 5 is advantageously followed by the current collector 7, formed from carbon paper, which conducts the current out of the cell to the bipolar or terminal plate.

The fuel cell described is operated at a temperature of from 100° C. to 250° C., preferably from 130° C. to 220° C., and in particular of 200° C., and/or an operating pressure of from 3 to 7 bar, in particular of 5 bar.

Particularly during a cold start, therefore, the fuel cell is operated with a liquid fuel while it is starting up. When the operating pressure and/or the operating temperature are high enough, the reforming reaction commences, and the cell is no longer operated with a methanol/water mixture, but rather with reformer gas as the fuel. Generally, at low pressure, even when a gaseous fuel is present, the cell is operated as a direct methanol cell, while at a high operating pressure and at a high operating temperature the cell is operated in a reformer/hydrogen mode.

The methanol/water mixture, which is used as the fuel for operation as a direct methanol fuel cell, is preferably composed of 0.5 mol/l to 20 mol/l of methanol and 55 mol/l to 20 mol/l of water.

The “anodic electrode coating of the membrane electrode assembly” or the “active catalyst layer 2 for the anodic oxidation”, at which protons, i.e. hydrogen ions and electrons, are obtained from the hydrogen, preferably contains a support, to the surface of which the catalyst, such as for example platinum or a platinum/ruthenium alloy, is applied. The support is preferably electronically conductive, for example is a carbon powder or carbon black.

According to one embodiment of the cell, the distribution of the metallic catalyst, which is very expensive since it includes precious metals, in the active catalyst layer follows a distribution gradient, so that the concentration of catalyst is highest at the location where the catalytic activity is most required, e.g. at the point of contact between the active catalyst layer and the membrane, and the concentration of the catalyst is lower at locations where the conversion rate and also therefore the demand for catalyst is lower, e.g. on that side of the active catalyst layer which is remote from the membrane. Not only can the catalyst to support ratio be described by the distribution gradient, but so also can the ratio of metal I to metal II. For example, the more expensive metal may, at the boundary with the membrane, be present in a ratio of 1:1, as is most favorable for the catalytic activity, while on the side which is remote from the membrane it may be present in a ratio of only the concentration of the catalyst in the anodic electrode coating of the MEA is accordingly described as variable.

According to another embodiment, the active catalyst layer of the anode contains only the metallic catalyst that, although it is expensive, keeps the current transfer losses within acceptable limits.

The reformer catalyst layer 5 includes various metals; by way of example, a catalyst mix containing copper and zinc based on corundum (Al₂O₃) has proven appropriate.

The reformer catalyst layer 5 has a mass of between 3 and 50 mg/cm2, preferably between 7 and 30 mg/cm2, and particularly preferably between 10 and 15 mg/cm2.

The reformer catalyst layer 5 is permeable to gas and/or liquid. The reforming of the fuel takes place during the reaction at the catalyst layer, i.e. at the layer the methanol/water mixture is substantially converted into hydrogen and carbon monoxide. At the anode, the carbon monoxide is converted into carbon dioxide, which is not a catalyst poison and is a relatively neutral and an acceptable exhaust gas.

The anodic transfer of current through the cell is critical, since the cell has, instead of one catalyst layer, two catalyst layers, through which the current produced at the anode/membrane interface is to be conducted to the bipolar plate as far as possible without major losses. Therefore, it is advantageous if the catalyst for the reforming reaction is applied to a support with a good electronic conductivity, such as for example carbon black and/or carbon powder, since the catalyst for the reforming reaction is neither a good current conductor nor a good heat conductor.

The membrane electrode assembly (MEA) used here advantageously contains the membrane 1 with the electrode coating 2, 3 on both sides and, depending on the particular configuration, a current collector such as carbon paper which under certain circumstances may have been made hydrophobic. The electrode coating contains an active catalyst layer 2 or 3 that, if appropriate, has the catalyst on an electronically conductive support.

The fuel cell described therefore operates—depending on the operating mode—at times as a direct methanol fuel cell and at other times as a PEM fuel cell that is operated with hydrogen. Operation as a high-temperature fuel cell, i.e. a HT-PEM fuel cell, is achieved at relatively high operating temperatures.

There are therefore particular advantages for practical use. This is possible if each fuel cell unit includes an internal reformer layer, at which the reforming reaction takes place given a sufficiently high pressure and/or temperature, this reaction involving the fuel methanol/water being converted into hydrogen. Disposing the reformer catalyst layer inside the cell ensures that the heat of the anode is utilized for the reforming and, conversely, the anode is cooled by a endothermic reforming reaction.

I claim:

1. A fuel cell, comprising:
a reformer having a reformer chamber formed therein;
a membrane electrode assembly having an anode chamber formed therein and an anodic electrode coating, said anodic electrode coating suitable for a conversion of methanol and for a conversion of hydrogen; and
a reformer catalyst layer disposed in said anode chamber following said anodic electrode coating of said membrane electrode assembly (MEA).

2. The fuel cell according to claim 1, further comprising a separator disposed between said anodic electrode coating of said membrane electrode assembly (MEA) and said reformer catalyst layer.

3. The fuel cell according to claim 1, wherein said anodic electrode coating has a catalyst and at least one of a concentration and a composition of said catalyst is variable.

4. The fuel cell according to claim 1, wherein said reformer catalyst layer is present in an amount of from 3 to 50 mg/cm2.

5. The fuel cell according to claim 1, wherein said membrane electrode assembly has a membrane reinforced with a woven textile fabric.

6. A method for operating a fuel cell, which comprises the steps of:
operating the fuel cell at at least one of a low pressure and a low temperature as a direct methanol fuel cell (DMFC); and
operating the fuel cell at at least one of a high pressure and a high temperature as a polymer electrolyte membrane (PEM) fuel cell operating with hydrogen.

7. The method according to claim 6, which comprises utilizing the direct methanol fuel cell during a cold start of the fuel cell.

8. The method according to claim 7, which comprises reacting a liquid methanol/water mixture at an anode in an event of a cold start, while the fuel cell is starting up.

9. The method according to claim 6, which comprises during long-turn operation, at least one of an operating pressure and an operating temperature are sufficient for a reforming reaction to take place inside the fuel cell.

10. The method according to claim 6, which comprises during operation, at least one of an operating temperature of al least 150° C. and an operating pressure of at least 5 bar prevails.

11. The method according to claim 10, which comprises during long-term operation, operating the fuel cell as a high-temperature polymer electrolyte membrane (HT-PEM) fuel cell.
